(19) United States
(12) Patent Application Publication
(10) Pub. No.: US 2013/0048709 A1
(43) Pub. Date: Feb. 28, 2013

(54) METHOD AND APPARATUS FOR AUTOMATIC ENCODED SIGNAL INFORMATION DELIVERY

(71) Applicant: Gary Turner, Parker, CO (US)

(72) Inventor: Gary Turner, Parker, CO (US)

(21) Appl. No.: 13/465,897

(22) Filed: May 7, 2012

Related U.S. Application Data
(60) Provisional application No. 61/482,977, filed on May 5, 2011.

(51) Int. Cl. G06F 17/30

(52) U.S. Cl. 235/375

(57) ABSTRACT

Methods and systems for automatic encoded signal information delivery are provided. Specifically, an encoded signal source may present a signal that is capable of being received by a configured communication device. An application functioning on the communication device is automatically configured to interpret the signal and alert the user for possible input. It is anticipated that the application may provide more information to a user associated with the encoded signal. This information may be stored locally and/or remotely and may be accessed via a request from the communication device.

### CROSS REFERENCE TO RELATED APPLICATION

The present application claims the benefits of and priority, under 35 U.S.C. §119(e), to U.S. Provisional Application Ser. No. 61/482,977, filed May 5, 2011, entitled “METHOD AND APPARATUS FOR A TONE-BASED PRODUCT INFORMATION DELIVERY SYSTEM.” The aforementioned document is incorporated herein by this reference in its entirety for all that it teaches and for all purposes.

### BACKGROUND

The use of barcode applications with smart communication devices such as smartphones has become increasingly popular. Barcode scanners are part of an emerging “tagging” architecture that works to tie the physical world to the digital by integrating individual's smart devices to the digital marketplace. Bar codes are increasingly being integrated into the media and advertising in magazines, on posters, and on television.

In a typical barcode application, a user seeking information about a product can use a smartphone's camera to scan a product barcode. The smartphone application then decodes the barcode, consults a database, and provides specific product information to the user. Some applications also allow a smart device to store information for future use, or allow a smart device to forward the information to other smart devices. The barcodes scanned are often two-dimensional bar codes designed to be scanned by a smartphone, for example mobile tags, action codes, Universal Product Code (UPC), and Quick Response (QR) codes. The product information provided to the user often includes where the product can be purchased, the price of the product, price comparisons within a specified city or radius, product reviews, and information about specials or discounts.

UPC is the barcode symbology that is widely used in Canada and the US to track consumer goods in the manufacturing and retail environments. Each manufacturer is given a manufacturer identification number, which is then converted into a machine-readable barcode and a 12-digit human-readable UPC code. Other countries use similar code systems based on the UPC code structure. For example, Europe uses a barcode and a 13-digit code known as a European Article Number, or EAN. Japan uses a compatible code with the EAN known as the Japanese Article Number (“JAN”) scheme. All UPC codes, and their foreign equivalents, can be accessed via a UPC (or equivalent) database.

A QR code is a two-dimensional matrix bar code that is used to identify products. It can store up to 4,296 alphanumeric or 7,089 numeric characters. QR codes were originally created by the Japanese corporation known as Denso Wave, Inc. and standardized by ISO, Japanese Industrial Standard (JIS), JEIDA and AIM. Some companies have created billboard-sized QR codes for the purpose of communicating information such as a company's website URL address to smartphone users.

Shazam is another company that has made use of tagging technology to provide information to users. A smartphone with the Shazam application installed can be held up to a music broadcast source to identify the name of the song being played. Shazam uses a smartphone's built-in microphone to gather a brief sample of music being played. An acoustic fingerprint is created based on the sample, and is compared against a central database for a match. If a match is found, information such as the artist, song title, and album are relayed back to the user.

Most recently, Near Field Communications (NFC) have been employed in the tagging architecture. NFC are a group of wireless technologies that have an extremely short range, typically 1-3 inches. This contactless technology typically takes the form of a small chip embedded in a phone, card, and/or other substrate. When the object containing the small chip is tapped against or placed within the proximity of a reader device, a transaction (such as payment) can take place, based on stored-value information in the phone, card, and/or other substrate. However, NFC technology requires special equipment to transmit and/or receive data, and as such, has not been widely adopted by the tagging industry.

Smartphones now account for an ever-increasing share of the US mobile market, however current use of barcode technology is hampered by competing bar code standards and scanning programs. The use of barcodes applications on smartphones is also slowed by the relative lack of smartphones that have the appropriate software, and some consumer's difficulty in adapting to new technologies. Most importantly, the tagging architectures described above fail to deliver information automatically to a user. In fact, each technology requires that the user initiate an inquiry about a product by scanning a barcode, taking a music sample, or placing a device in the vicinity of a chip.

### SUMMARY

These and other needs are addressed by various embodiments and configurations of the present application. The present disclosure relates to a process, apparatus, and system that allow a communication device to automatically gather product information related to a source of advertising such as a transmission, sign, billboard, or other display, the source of advertising transmitting or displaying a code via one or more “encoded signal” such as a barcode, an encoded tone, an encoded video message, and Wi-Fi signal. The communication device can then alert a user that information is available, and if the user opts to receive the information, deliver the information to the user. Furthermore, the communication device may be configured to store and/or sort product and/or user information on specific products through barcode scanners and tone recognition, audio recognition, Wi-Fi, and/or combinations thereof. While the disclosure is presented in terms of exemplary embodiments, it should be appreciated that individual aspects of the disclosure can be separately claimed.

In accordance with at least some embodiments of the present invention, a system, device and method is provided for providing information to a user, comprising:
receiving an identifier for a product or service, the identifier being provided in a first format;
converting the identifier for the product or service from the first format to a second format which includes one or more sound waves; and
providing the identifier in the second format to a user device, wherein the identifier in the second format uniquely describes the product or service with altered properties of the one or more sound waves.

The present disclosure can provide a number of advantages depending on the particular aspect, embodiment, and/or configuration. For instance, it has been determined that requiring a user to activate a communication device application to initiate a scan, an audio and/or video sample, and/or Wi-Fi signal to receive information is a cumbersome and sometimes problematic process. Moreover, the process requires that the user is aware that information is capable of being received. Once the user determines that such information is available, that user must then select to retrieve that information. This process can be problematic, as users often have divided attention. Further, the users may not understand that they can scan a display to gain more information. Additionally or alternatively, the users may be in a hurry, or may not have their hands free to operate their communication device (e.g., while driving, preparing meals, working, and the like). Providing an automatic communication device alert that such information is available increases the odds that a user will opt to receive that information. This automatic alert can, therefore, increase the chance that advertisers will connect with interested consumers. These and other advantages will be apparent from the disclosure.

In some embodiments, QR codes, barcodes, 2D codes, 3D codes, and other codes/symbols may be scanned and the information associated with the codes/symbols may be converted to inaudible tones. These inaudible tones may be used to trigger second screens and/or devices for the presentation of information. In one embodiment, a device may interpret and/or receive an encoded signal (e.g., video, audio, and the like) and use the encoded signal to receive more information from additional sources/devices. For instance, a device may interpret and/or receive an encoded signal that causes the device to periodically, or continuously, emit inaudible tones to radio, video, and/or graphic billboard devices that are configured to respond to the emitted tones. These tones may be caused to emit based on the geographical location of the device, the presence of display/audio devices configured to respond to such tones, and/or state of the device. In one example, a user may receive a first encoded signal via a first device from a first advertising point. Upon moving to a second advertising point, such as a graphic billboard or interactive kiosk, the first device may emit tones associated with the received encoded signal to initiate an interactive delivery of content. This content may include commercial information, advertisements, and/or other information related to advertising.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participate in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The terms “communication device,” “smartphone,” and “mobile device,” and variations thereof, as used herein, are used interchangeably and include any type of device capable of communicating with one or more of another device and/or across a communications network, via a communications protocol, and the like. Exemplary communication devices may include but are not limited to smartphones, handheld computers, laptops, netbooks, notebook computers, subnotebooks, tablet computers, scanners, portable gaming devices, phones, pagers, GPS modules, portable music players, and other Internet-enabled and/or network-connected devices.

The term “display” refers to a portion of one or more screens used to display the output of a computer to a user. A display may be a single-screen display or a multi-screen display, referred to as a composite display. A composite display can encompass the touch sensitive display of one or more screens. A single physical screen can include multiple displays that are managed as separate logical displays. Thus, different content can be displayed on the separate displays although part of the same physical screen.

The term “module” as used herein refers to any known or later developed hardware, software, firmware, artificial intelligence, fuzzy logic, or combination of hardware and software that is capable of performing the functionality associated with that element.

The terms “determine”, “calculate” and “compute,” and variations thereof, as used herein, are used interchangeably and include any type of methodology, process, mathematical operation or technique.

It shall be understood that the term “means” as used herein shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the invention, brief description of the drawings, detailed description, abstract, and claims themselves.

The preceding is a simplified summary of the disclosure to provide an understanding of some aspects of the disclosure. This summary is neither an extensive nor exhaustive overview of the disclosure and its various aspects, embodiments, and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and/or configurations of the disclosure are possible utilizing, alone or in combination, one or more of the features set forth above or described in detail below.

### BRIEF DESCRIPTION OF THE DRAWINGS

FIG. 1 is a block diagram depicting an encoded signal information delivery system in accordance with embodiments of the present disclosure;

FIG. 2A depicts a communication between a signal source and a communication device in accordance with embodiments of the present disclosure;

FIG. 2B depicts a communication between a communication device and a user in accordance with embodiments of the present disclosure;

FIG. 3 is a block diagram of an embodiment of the hardware of a communication device;

FIG. 4 is a block diagram depicting communication modes of a communication device in accordance with embodiments of the present disclosure;

FIG. 5 is a flow diagram depicting a first method of a communication device application in accordance with embodiments of the present disclosure;

FIG. 6 is a flow diagram depicting a second method of a communication device application in accordance with embodiments of the present disclosure;

FIG. 7 is a flow diagram depicting a third method of a communication device application in accordance with embodiments of the present disclosure;

FIG. 8 is a flow diagram depicting a fourth method of a communication device application in accordance with embodiments of the present disclosure;

FIG. 9 is a block diagram depicting a data structure of a user profile in accordance with embodiments of the present disclosure; and

FIG. 10 is a block diagram depicting a data structure of stored management data in accordance with embodiments of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

The disclosure will be illustrated below in conjunction with an exemplary communication device application. Although well suited for use with, e.g., a smartphone, and/or a system using a server(s) and/or database(s), the disclosure is not limited to use with any particular type of device or configuration of system elements. Those skilled in the art will recognize that the disclosed techniques may be used in any communication device application in which it is desirable to manage the information delivery via one or more encoded signal.

Presented herein are embodiments of a communication device application and information delivery system. The application can operate on a smartphone, tablet computer, laptop computer, or other device configured to receive and/or interpret signals. In some embodiments, the communication device application can automatically provide product information to a user via one or more unique methods. The overall design and functionality of the application provides for an enhanced user experience making the application more useful and more efficient.

For purposes of explanation, numerous details are set forth in order to provide a thorough understanding of the present invention. It should be appreciated, however, that the present invention may be practiced in a variety of ways beyond the specific details set forth herein.

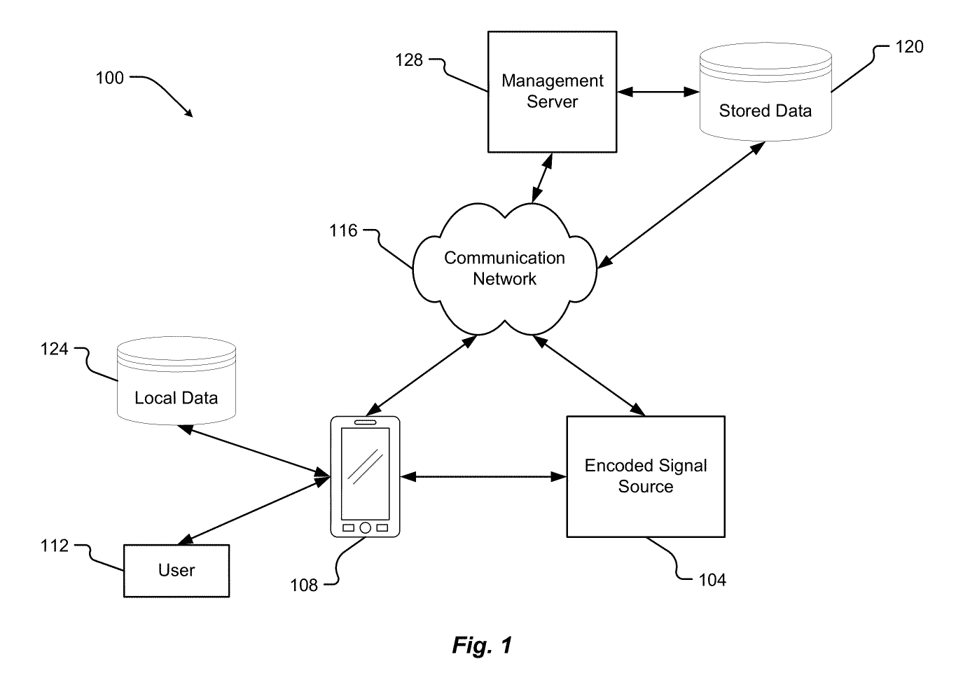

Referring to FIG. 1, a block diagram is shown depicting an encoded signal information delivery system 100 in accordance with embodiments of the present disclosure. The encoded signal information delivery system 100 may comprise one or more encoded signal source 104. In some embodiments, the encoded signal source 104 may be configured to generate, display, and/or transmit at least one encoded signal to a communication device 108 via direct communication and/or through a communication network 116. The encoded signal information delivery system 100 may comprise a communication network 116 that facilitates communications (e.g., voice, audio, radio, image, video, data, non-voice representations of voice data, and combinations thereof) between various communication devices 108.

The communication network 116 may be any type of known communication medium or collection of communication mediums and may use any type of protocols to transport messages between endpoints. The communication network 116 may include wired and/or wireless communication technologies. The Internet is an example of the communication network 116 that constitutes an IP network consisting of many computers and other communication devices located all over the world, which are connected through many telephone systems and other means. Other examples of the communication network 116 include, without limitation, a standard Plain Old Telephone System (POTS), an Integrated Services Digital Network (ISDN), the Public Switched Telephone Network (PSTN), a Local Area Network (LAN), a Wide Area Network (WAN), a cellular communication network, a cable communication network, a satellite communication network, any type of enterprise network, and any other type of packet-switched or circuit-switched network known in the art. It can be appreciated that the communication network 116 need not be limited to any one network type, and instead may be comprised of a number of different networks and/or network types.

In some embodiments, the encoded signal source 104 may be one or more broadcasting entity configured to distribute audio, data, and/or video content to remote and/or local user devices. The broadcasting entity may be commercial and/or private in nature. For instance, a broadcast entity may include one or more paid content providers (e.g., premium cable and/or satellite channels). It is anticipated that an encoded signal may be transmitted as a part of the broadcast programming of a broadcasting entity (e.g., shows, station identification, commercials, advertisements, etc.).

In other embodiments, the encoded signal source 104 may include a data carrier or the like. A data carrier may include an entity that controls and/or administrates a transmission medium such as circuit-switched networks, packet-switched networks, radio, television, etc. Examples of a typical data carrier may include but are not limited to the following types of companies: telephone, mobile phone, satellite, cable television, 3G/4G data, and GPS provider. Among other things, the data carrier may transmit an encoded signal as part of its periodic carrier identification routine, registration, and/or along with other content transfers made on the data carrier medium.

In yet another embodiment, the encoded signal source 104 may include at least one physical device configured to present one or more encoded signal. Physical devices may include but are not limited to one or more of a monitor, television, display, radio, speaker, tactile sound transducer, wireless data transmitter, Wi-Fi device, and the like. In some cases, the encoded signal may be represented by one or more vibrations caused by a physical device. In other cases, the encoded signal presented by the physical device may be visible and/or invisible to the human eye. Additionally or alternatively, the encoded signal may be audible and/or inaudible to the human ear. In some cases, the physical device may present an encoded signal along with a human-detectable (visible/audible) notification that the encoded signal is present. For instance, an advertisement may be displayed on a television wherein the advertisement is configured to transmit an encoded signal (with the advertisement) via combinations of light output that may be imperceptible to the human eye. In this case, the advertisement may include a visible notification to indicate the presence of an encoded signal. Alternatively, a radio advertisement may be played to transmit an encoded signal before, during, and/or after the advertisement. In this case, although the encoded signal of the radio advertisement may be inaudible, the advertisement may include an audible identification, or notification, to indicate the presence of an encoded signal. Informing people that information in the form of an encoded signal is available may, among other things, instill a sense of curiosity in the individual and/or inform the people that information is presented that may not be detectable by ordinary means.

It is anticipated that the encoded signal may be active and/or passive. In some cases, an encoded signal may actively interact with a communication device 108. For instance, the encoded signal source 104 may present an encoded signal to a communication device 108, for the purposes of seeking more information from the device 108. In this scenario, the encoded signal may be constructed to detect and even present information based on a particular user 112 of a communication device 108 in a given range. An exemplary use of this type of active signaling may include presenting information to a user 112 based on preferences stored in memory 120, 124. The encoded signal source 104 may send an encoded message to a communication device 108 to determine user 112 information that may be stored in memory 120, 124. Upon detecting the encoded signal, the communication device 108 may respond with a signal providing certain user 112 preferences. The encoded signal source 104 may respond by sending information to the communication device 108 in accordance with the user 112 preferences.

Additionally or alternatively, the encoded signal may be passive. Passive signals are those signals presented by an encoded signal source 104 to one or more communication devices 108 and/or users 112 regardless of preference information or inquiries. Examples of passive signals may include displayed codes, single transmissions, and/or repeating signals (e.g., audio, video, and/or wireless data). Passive signals may be employed by encoded signal sources 104 that are incapable of interacting directly with a communication device 108. For instance, an encoded signal source 104 may provide an encoded signal to at least one communication device 108. The communication device 108 may interpret the encoded signal and refer to local data 124 and/or a user 112 to determine the information to provide. In some cases, the communication device 108 may contact a management server 128 across a communication network 116 to determine the information associated with the encoded signal. The management server 128 may contain rules to determine whether to provide the information to the communication device 108. These rules may direct the management server 128 to refer to stored data 120 and/or local data 124 in providing information to the communication device 108. It is an aspect of the present disclosure that the communication device 108 may communicate with the management server 128 to intelligently receive information in accordance with custom set, and/or default, user settings. These user settings, or preferences, may be stored locally and/or remotely.

It can be appreciated that the method and intelligence associated with the management server 128 and/or stored data 120 may be accessed locally, for example, on a communication device 108 via a local data 124 store.

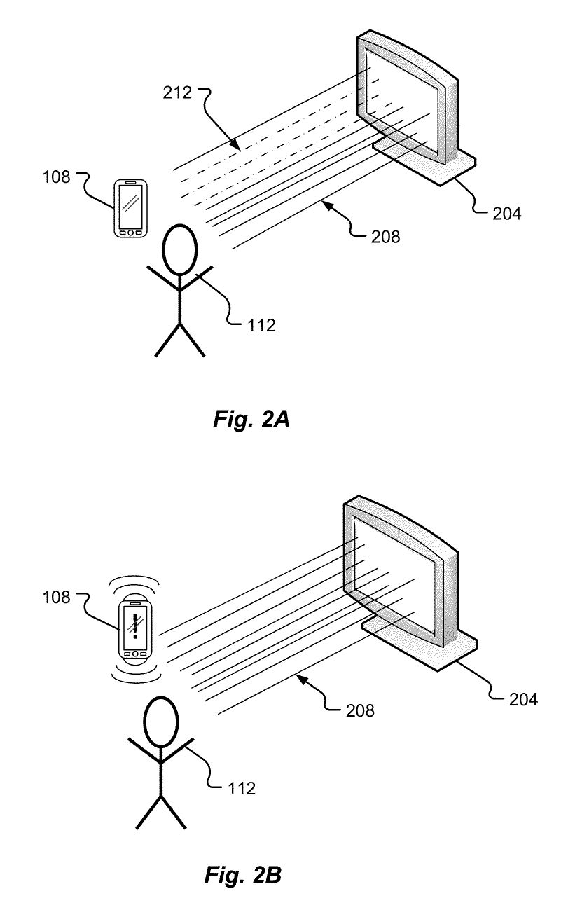

FIG. 2A depicts a communication between a signal source 204 and a communication device 108 in accordance with embodiments of the present disclosure. As depicted, the signal source 204 may be a television, monitor, display, and/or other video/audio transmitting device. In some embodiments, the signal source 204 may exhibit similar, if not identical, behavior to that of the encoded signal source 104 disclosed herein (see FIG. 1).

In one embodiment, the signal source 204 may produce one or more perceptible signals 208 that are capable of being perceived by one or more users 112. These perceptible signals 208 may be in the form of video, audio, and/or combinations thereof. Moreover, the perceptible signals 208 may be a part of regular programming, advertisements, information presentation, and/or some other transfer of content. While the perceptible signals 208 are perceived by the user 112, the signal source 204 may be configured to transmit encoded signals 212 to the communication device 108. These encoded signals 212 may be configured to be imperceptible to a user 112. For example, a user 112 may be watching a television show being broadcast on a television. In other words, the content of a message and/or show may be displayed to a user 112 via the perceptible signals 208. At a commercial break, and/or during an “interactive section” of the programming, the television (signal source 204), may present visual and audio content to the user 112 (perceptible signals 208) while encoded signals 212 are transmitted to a communication device 108 associated with the user 112. As previously stated, the encoded signals may be configured to be imperceptible by a user 112 directly.

It is an aspect of the present disclosure that the encoded signals 212 may be in the form of video, audio, wireless data transmission and/or combinations thereof. As previously stated, the perceptible signals 208 may include information identifying the existence of encoded signals 212. In some embodiments, the communication device 108 may be configured to detect the presence of encoded signals 212. As can be appreciated, the communication device 108 may include combinations of hardware and/or software to facilitate the detection and interpretation of encoded signals 212.

FIG. 2B depicts a communication between a communication device and a user in accordance with embodiments of the present disclosure. In some embodiments, when an encoded signal 212 is received by a communication device 108, the communication device 108 may alert the user 112. This alert may be achieved by at least one output from the communication device 108 such as visual, audible, tactile, and/or combinations thereof. A visual alert may include a notification, or “pop-up,” on a user interface (UI) associated with the communication device 108. This notification may include details/information regarding the encoded signal 212. Additionally or alternatively, the notification may provide the user 112 with input options regarding the delivery of information associated with the encoded signal 212. An audible alert may include an alarm, tone, and/or voice translation of the notification. The tactile alert may provide the user 112 with vibration indication of available encoded signal 212 information. It is anticipated that a user 112 can set and/or adjust the alert settings based on preferences. These preferences may be stored locally and/or remotely.

It is an aspect of the present disclosure that the user 112 may be alerted automatically, by way of a special application installed on the communication device 108. The application may be operated in multiple modes, where at least one mode is configured to monitor for encoded signals 212.

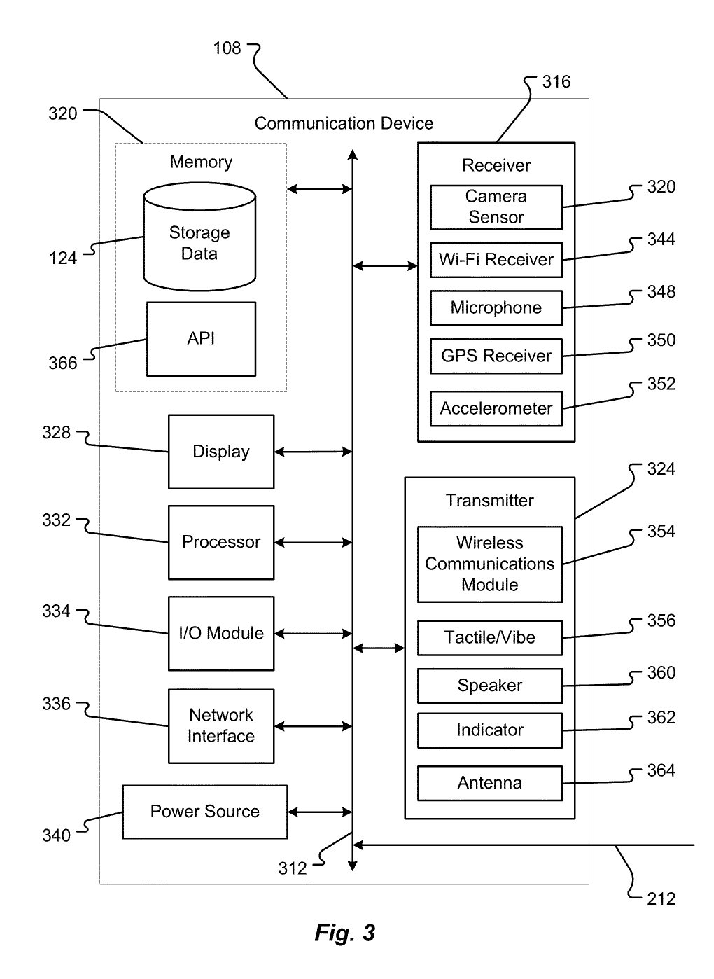

Referring now to FIG. 3, a block diagram of an embodiment of the hardware of a communication device 108 is shown. In general, the communication device 108 includes at least one power source 340, processor 332, memory 320, receiver 316, display 328, and bus 312. In some embodiments, the communication device 108 may further comprise at least one transmitter 324 and network interface 336. The communication device 108 may be configured to receive one or more encoded signals 212 via at least one of the receivers 316. Typical receivers may include but are not limited to a camera sensor 320, Wi-Fi receiver 344, microphone 348, global positioning system (GPS) receiver 350, and accelerometer 352.

Communications between various components of the communication device 108 can be carried by one or more buses 312. In addition, power can be supplied to the components of the communication device 108 from a power source 340. The power source 340 can, for example, include a battery, an AC to DC converter, power control logic, and/or ports for interconnecting the communication device 108 to an external source of power.

The processor 332 may comprise a general purpose programmable processor or controller for executing application programming or instructions. In accordance with at least some embodiments, the processor 332 may include multiple processor cores, and/or implement multiple virtual processors. In accordance with still other embodiments, the processor 332 may include multiple physical processors. As a particular example, the processor 332 may comprise a specially configured application specific integrated circuit (ASIC) or other integrated circuit, a digital signal processor, a controller, a hardwired electronic or logic circuit, a programmable logic device or gate array, a special purpose computer, or the like. The processor 332 generally functions to run programming code or instructions implementing various functions of the communication device 108.

A communication device 108 may also include memory 320 for use in connection with the execution of application programming or instructions by the processor 332, and for the temporary or long term storage of program instructions and/or data. As examples, the memory 320 may comprise RAM, DRAM, SDRAM, or other solid state memory. Alternatively or in addition, data storage 124 may be provided. Like the memory 320, the data storage 124 may comprise a solid state memory device or devices. Alternatively or in addition, the data storage 124 may comprise a hard disk drive or other random access memory. In some embodiments, the memory 320 may be further configured to operate applications on the communication device 108 via an application programming interface (API) 366. The API 366, may be configured to direct applications installed on the communication device 108 and/or stored in data storage 124 to perform application tasks in accordance with specific program functionality.

The communication device 108 can also include a GPS receiver 350. In accordance with embodiments of the present invention, the GPS receiver 350 may further comprise a GPS module that is capable of providing absolute location information to other components of the device 108. An accelerometer(s) 352 may also be included. For example, encoded signals 212 may be received via use of an accelerometer 352 and/or gyroscope. In particular, encoded signals 212 may be received from one or more vibrations detected by an accelerometer 352 and/or gyroscope associated with the communication device 108.

In some embodiments, the communication device 108 may include a display 328. The display 328 may be configured to present information to a user 112 related to encoded signals 212 received. Examples of displays 328 include but are not limited to liquid crystal display (LCD), light emitting diode (LED), organic LED (OLED), active matrix OLED (AMOLED), capacitive-touch, resistive-touch, and the like. One or more display controllers may be provided as part of the display 328 for controlling the operation of a touch-sensitive display including input (touch sensing) and output (display) functions.

An input/output module 334 and associated ports may be included to support communications over wired networks or links, for example with other communication devices, server devices, and/or peripheral devices. Examples of an input/output module 334 include an Ethernet port, a Universal Serial Bus (USB) port, Institute of Electrical and Electronics Engineers (IEEE) 1394, or other interface.

Other network connections, including those connections achieved through wireless protocols may be facilitated by the use of a network interface 336. The network interface 336 may be configured to communicate with one or more cellular, packet-switched, circuit-switched, and/or local network.

In support of communications functions or capabilities, the communication device 108 can include a transmitter 324. As examples, the transmitter 324 can comprise a GSM, CDMA, FDMA and/or analog cellular telephony transceiver capable of supporting voice, multimedia and/or data transfers over a cellular network. Alternatively or in addition, the communication device 108 can include an additional or other wireless communications module 354. As examples, the other wireless communications module 354 can comprise a Wi-Fi, BLUETOOTH™, WiMax, infrared, or other wireless communications link. The transmitter 324 and the other wireless communications module 354 can each be associated with a shared or a dedicated antenna 364. In some embodiments, the communication device 108 may include a tactile sound transducer and/or vibratory unit 356 to provide feedback and/or alert to a user 112. Additionally or alternatively, the communication device 108 may include one or more speakers 360 to output audio to a user 112 or other device. In some embodiments the output from a speaker 360 may be used to indicate an alert or information related to an encoded signal 212. Similarly, the communication device 108 may make use of one or more light indicators 362 to communicate and/or indicate alerts and the like. The indicator 362 may be a display, light emitting diode (LED), light source, infrared transmitter, and/or other light emitting device.

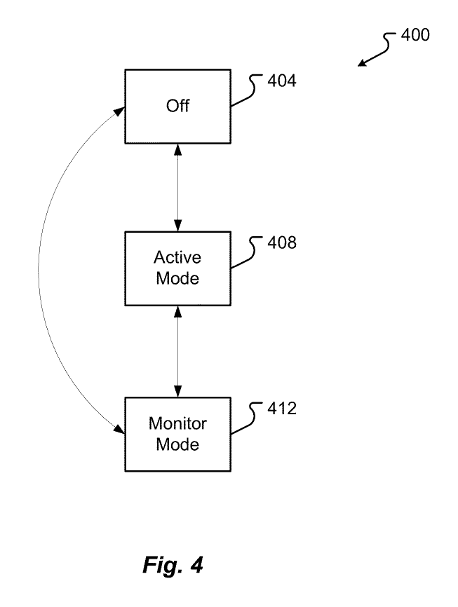

FIG. 4 is a block diagram depicting communication modes 400 of a communication device 108 in accordance with embodiments of the present disclosure. In general, an encoded signal information delivery (ESID) application associated with a device 108 may be operated in one or more states, or modes. The state of the ESID application can be determined by communication device state, user preferences, default settings, and/or combinations thereof. In the “Off” state 404 the encoded signal information delivery application does not operate to receive, interpret, or interact with the communication device 108. However, it is anticipated that the ESID application may be caused to initiate, and transition to an “Active Mode” 408 or “Monitor Mode” 412, based on a state of the communication device 108. For instance, the communication device 108 may be turned on within range of a specific network. Upon detecting the specific network, the communication device 108 state may cause the ESID application to initiate. Alternatively or additionally, it is expected that the communication device 108 state when turned off may return the ESID application to an Off state 404.

In some embodiments, the Active Mode 408 may be used by the ESID application to actively and/or continuously seek encoded signals 212. This mode may be particularly useful in a scenario where a user 112 may wish to receive multiple encoded signals 212 relating to available retail offers in an area. For example, a user 112 may be shopping in a town center and may wish to receive information regarding available coupons and/or deals in the area. In this instance, the user 112 may set the ESID application to an Active Mode 408 to seek out available (and/or nearby) deals. The user 112 may then review the offers and associated information and decide which shops to frequent in the town center. As can be appreciated, the user 112 may set preferences to initiate the Active Mode 408 of the ESID application. For instance, a user 112 may set geographical limits, or geo-fences, to set states of the ESID application. Additionally or alternatively, the user 112 may include filter criteria in a user preferences data store to refine the sought results. In some embodiments, a communication device 108 operating an ESID application in Active Mode 408 may switch to an Off mode 404 or to the Monitor Mode 412 of the ESID application.

As can be appreciated, the communication device 108 may have multiple power states associated with its operation. Most communication devices, including smartphones, tablets, handheld computers, and the like, do not have simple “On/Off” states. To differentiate between these power states, the following terminology will be used to better define the multiple power states of a communication device 108. “Device Off” is used to indicate that the communication device 108 is completely turned off; in other words, virtually no power is being used by the communication device 108 in this state. When “Device Off” the communication device 108 cannot receive or transmit communications, signals, alerts, and the like. “Device On” is used to indicate that the communication device 108 is turned on, capable of receiving and transmitting communications, signals, and alerts, and power is directed to the display 328 and all recruited components. In some embodiments, “Device On” may indicate that the display 328 is fully powered. In another embodiment, a fully powered display 328 may indicate that the device is in a condition to detect input received at all areas of the display (e.g., touch-screen). “Device Lock” is used to indicate that power to the communication device 108 display 328 is limited, but the communication device 108 is capable of receiving and transmitting communications, signals, alerts, and the like. Device Lock saves battery power by reducing power supplied to the display while allowing applications to present an alert to the display 328 or other indicator 356, 360, 362 upon direction of the ESID application. In an embodiment where the display may comprise a touch-screen, a Device Lock state may cause reduced power to be directed to the display (e.g., in a limited area or section of the display). In accordance with some embodiments of the present disclosure, the ESID application may transition the communication device 108 from a Device Lock state to a Device On state.

It is an aspect of the present disclosure that Monitor Mode 412 can cause the ESID application to operate in a constant state of “awareness.” Among other things, Monitor Mode 412 is configured to “listen” for encoded signals 212 even when the communication device 108 is in a Device Lock state. In some embodiments, custom settings may direct which encoded signals 212 are presented to the user 112 while the communication device is operating in a given state or mode. These custom settings may be stored locally or remotely. A communication device 108 operating an ESID application in Monitor Mode 412 may switch to an Active Mode 408 or to the Off state 404 of the ESID application.

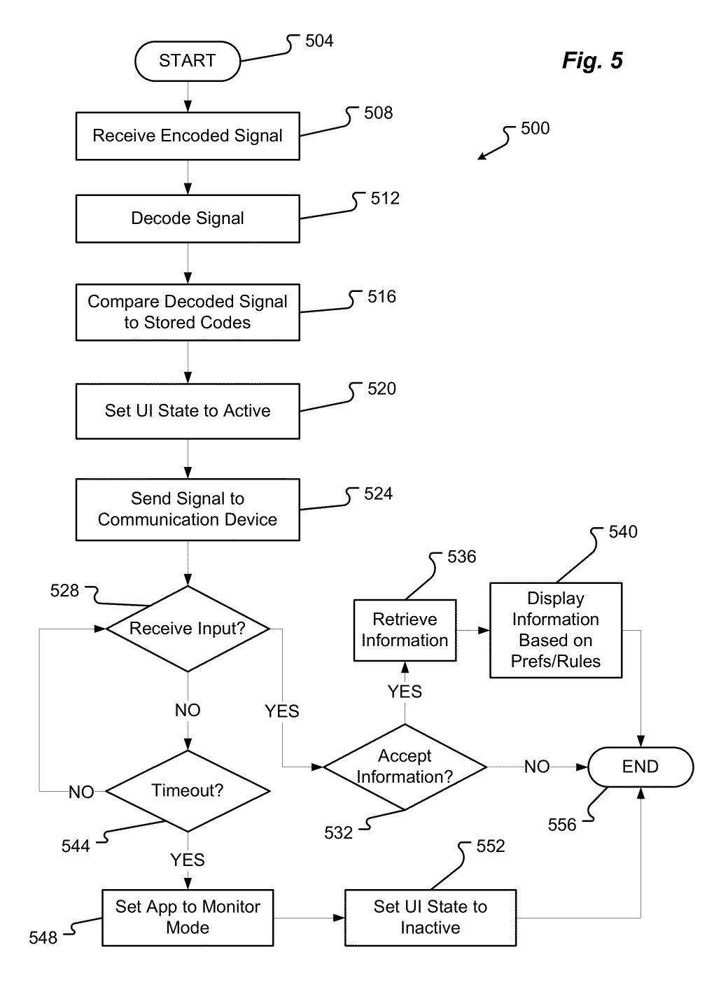

FIG. 5 is a flow diagram depicting a first method of a communication device 108 application in accordance with embodiments of the present disclosure. In particular the method discloses a first ESID application of a communication device 108 in accordance with embodiments of the present disclosure. As can be appreciated the ESID application may be operate on a communication device 108. Moreover, the ESID application may operate as software, firmware, artificial intelligence, fuzzy logic, or combination of hardware and software that is capable of performing the functionality associated with that application.

The ESID application begins at step 504 and proceeds upon receiving an encoded signal 212 (step 508). As disclosed herein, the encoded signal 212 may be received as light, sound, tactile input, and/or combinations thereof. In some embodiments, the encoded signal may correspond to information stored in memory. This information may include, but is not limited to, manufacturer details, advertisements, product information, news, interactive information, and/or other data. In an exemplary model, the encoded signal 212 may correspond to a code wherein the code represents unique information relating to a product or service. This code may be stored in memory and may even be registered and/or known as part of a national and/or international database. Similar to UPC codes and the like, the encoded signal 212 codes may be stored and/or managed by a group and/or organization.

The method continues by decoding the received encoded signal 212 (step 512). In some embodiments, the decoding process may involve separating the encoded signal 212 from one or more perceptible signals 208 and/or noise. This separation may be achieved using filters, tuned receivers, regulators, and other methods that are capable of isolating at least a signal, or a portion of a signal, from a group of signals. Other embodiments of the present disclosure anticipate that the decoding process begins by receiving a direct, or unmerged, encoded signal 212. Upon receiving the direct signal, the communication device 108, or other device 128, may recognize the signal as an encoded signal and continue with the method. In some cases, continuation of the method may include forwarding a decoded signal for comparison to stored and/or recognized codes. As can be appreciated, the decoding process, and other processes, disclosed herein may be performed by the communication device 108, or any other device, including but not limited to the management server 128. In other words, a communication device 108 may forward an encoded signal for further processing. Moreover, the processes disclosed herein may be performed by one or more devices across a communication network 116.

In some embodiments, the method 500 may continue by comparing the decoded signal to codes stored in memory (step 516). The codes may be stored remotely from a communication device 108 on a stored data 120 memory. Additionally or alternatively, the codes may be stored locally on, or associated with, the communication device 108 in a local data 124 memory. It is an aspect of the present disclosure that the codes are managed and/or stored by an organization to control the registration, association, and standards associated with the codes. These codes may relate to information about one or more manufacturers, service organizations, products, services, offers, advertisements, commercials, sources, and/or the sale of one or more items (physical and/or virtual). In the event that a match is not found during the comparison step 516, the method 500 may continue by presenting a message to the communication device 108 relating this information, and may even present an option for the user 112 of the device 108. Alternatively, upon detecting a match during the comparison step 516, the method 500 may proceed by presenting the communication device 108 with other options for a user 112.

The method 500 continues by setting the UI of the communication device 108 to an active state (step 520). In some instances, setting the UI to an active state may include setting a display 328 to an “On” state. In other instances, the active state may indicate that the communication device 108 is prepared to receive signals presented by the ESID application. It is an aspect of the present disclosure that setting an active state of the UI may be bypassed upon detecting that the communication device 108 is set in an active state.

It is an aspect of the present disclosure that the ESID application, and/or other device 128, may detect the availability of information based on the encoded signal 212 received and send a signal to the communication device 108 (step 524). This signal may include a prompt for the display 328 of a device 108 to turn to an “On” state. In some embodiments, the signal may include instructions for the ESID application, or communication device 108 operating system, to display a notification of available user 212 input options. The signal may indicate that information is available or that information was not found (e.g., communications interruption, corruption of data, file moved, private data encryption, etc.). In other embodiments, the ESID application may determine that no information is available for an encoded signal and prevent the display of information to a user 112. It is anticipated that the signal send to the communication device 108 may include options for user 112 input.

The method 500 continues by determining whether input is received at the communication device 108 (step 528). Input may be provided to the communication device 108 in a number of ways. In some instances, the input may be provided automatically and/or in response to a condition or state associated with the device 108. As can be appreciated, the input may include but is not limited to that provided via audio input (via a microphone 348 or similar device), hardware buttons, touch-screen display, accelerometer 352 data, GPS receiver information, camera sensor, and the like. In an exemplary embodiment, a user 112 may be presented with multiple options from which to select and provide input. For example, the ESID application may have determined that the encoded signal 212 corresponds to a code and/or information that can be transmitted to the communication device 108. In this case, the individual options provided may include “Accept Information,” “Decline Information,” and “Ignore Information.” Furthermore, each option may be coupled to a hardware or software button to allow for selection. Additionally or alternatively, the options may be selected by navigating via a mouse or other pointer. In some instances, the communication device 108 may not receive input from a user 112. This scenario may occur where the user 112 is busy, preoccupied, ignoring the signal, or did not notice the signal. If no input is received after a certain period of time, the method 500 may “timeout” (step 544). Upon timing out, the method 500 may continue by setting the ESID application to Monitor Mode 412 (step 548). It is anticipated that the device 108 UI may also be set to an “inactive state” (step 552). One example of an inactive UI state is setting the device 108 to a Device Lock state disclosed herein. In one embodiment, the ESID application may be set to Monitor Mode 548 concurrently with setting the UI state to “inactive.”

In the event that input is received, the method 500 continues by determining whether the input is directed to accepting the information associated with the encoded signal 212 (step 532). To continue with the example above, the communication device 108 may receive input such as “Accept Information.” This input may direct the ESID to retrieve information. On the other hand, the input may be to “Ignore Information” or “Decline Information.” In this case, and upon determining that a user 112 does not wish to receive information, the method 500 may end (step 556).

Upon receiving input to accept the transfer of information, the ESID application may direct the device 108 to retrieve information from memory 120, 124. As previously stated, the memory may be local 124, or it may be stored remotely 120. It is an aspect of the present disclosure that the ESID application and the communication device 108 may communicate across a network 116 to retrieve the information associated with the encoded signal 212.

When the information is retrieved, the information may be provided to the communication device 108 via the display 328. In some embodiments, the display of information may be formatted in accordance with user 112 preferences and/or rules stored in memory 120, 124. For example, a user 112 may desire to see only the price and description of product information displayed. Alternatively, another user 112 may wish to have the entire details of a product displayed in addition to website links provided via an interactive display of the information. It is anticipated that either display of information may be set by a user based on preferences. Exemplary embodiments of information associated with the encoded signal 212 are disclosed herein, and may include advertising information and data relating to products and/or services. The method 500 ends at step 556.

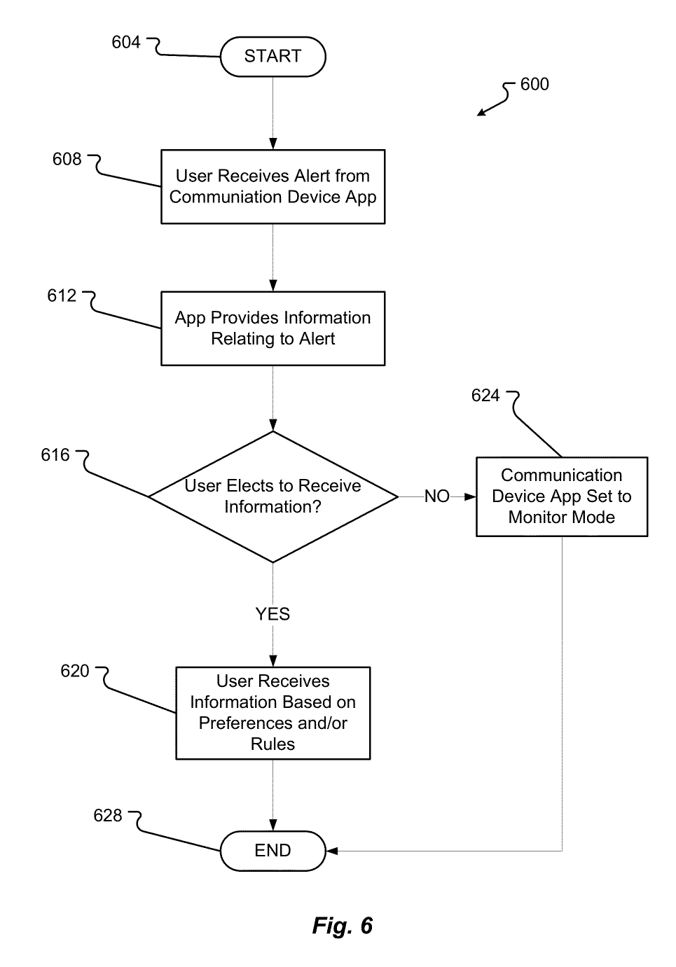

Referring to FIG. 6, a flow diagram depicting a second method 600 of a communication device 108 application is shown in accordance with embodiments of the present disclosure. In some embodiments, the ESID may solicit input from a user 112. The method 600 begins at step 604 and proceeds when the user 112 receives an alert at the communication device 108 from the ESID application (step 608). As previously disclosed, the alert may include at least one audio, tactile, and/or visual notification. In one embodiment, the ESID application may cause the communication device 108 to vibrate/ring and display information relating to the alert. The alert may be a notification regarding encoded signal 212 information.

The ESID application may provide information relating to the alert in the form of displayed information, audio, and/or speech (step 612). It is anticipated that the information relating to the alert may include a description of the information that is available. Exemplary embodiments may display an alert notification with a brief summary of available information. This alert may include options for selection by a user 112. Some of the expected options may include “Accept” and/or “Deny” receiving information.

The method 600 continues by determining the input received (step 616). In the event that the user 112 does not elect to receive information, the ESID application may be set to Monitor Mode 412. Determining that a user 112 has not elected to receive information may be achieved by a number of ways, for example utilizing a timer and/or by detecting a “Deny” input received.

The method 600 proceeds at step 620 upon determining that the user 112 has elected to receive information. Information is then provided to the user 112 based on preferences and/or rules. These preferences may include user preferences and/or preferences associated with the information. Rules may dictate times, states, behavior, and/or combinations thereof for presenting information to a user 112. The method 600 ends at step 628.

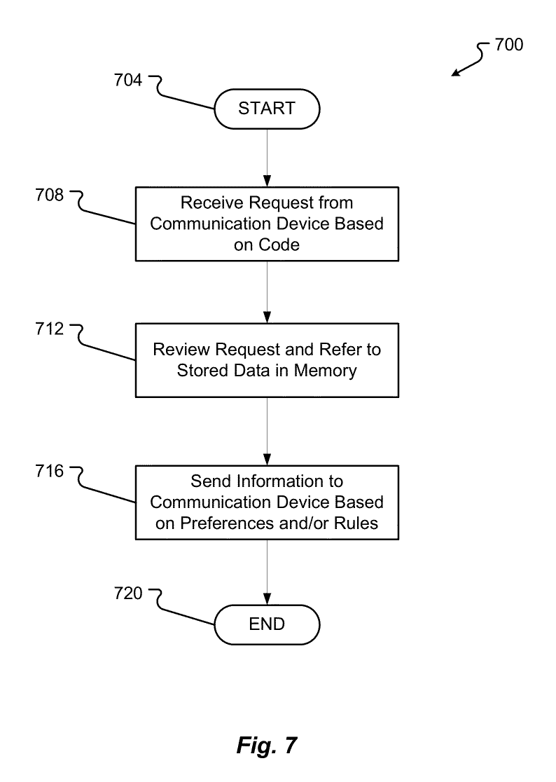

Referring now to FIG. 7, a flow diagram depicting a third method of a communication device 108 application is shown in accordance with embodiments of the present disclosure. In particular, the method 700 discloses an ESID application in communication with one or more memory 120, 124 and/or management server 128 to provide information based on communication device 108 requests. It is anticipated that the communication device 108 requests may be provided based on an output from an ESID application running on the device 108.

The method 700 begins at step 704 and proceeds upon receiving a request from a communication device 108 based on one or more encoded signal 212 (step 708). For example, the communication device 108 may detect an encoded signal 212 and an ESID application may determine to request information relating to the encoded signal 212. This request may be sent across a network 116 and/or be sent within a communication device 108 to a memory 124.

Upon receiving the request, the ESID application (at the management server 128, stored data 120, or local data 124) reviews the request for pertinent information and refers to memory 120, 124 for at least one match (step 712). The request may include a decoded signal obtained from the encoded signal 212. Additionally or alternatively, the request may include the encoded signal for processing by a management server 128. In some embodiments, the decoded signal may be compared to stored codes and/or information in memory 120, 124. When the memory 120 is stored remotely, the management server 128 may perform the comparison and search step.

The method 700 continues by sending information to the communication device 108 based on preferences and/or rules (step 716). Preferences may be stored locally and/or remotely in any number of memory locations. It is anticipated that the preferences may relate to one or more of information, encoded signal codes, and users. The preferences may determine the information presented, a configuration of displayed information, inputs provided, and/or alerts/notifications used in sending information. In some cases, the preferences may direct/specify the medium to use in sending information. For example, a user 112 may have preferences that direct the ESID application and/or management server 128 to send information over a specific network, via a specified port number, and/or via a certain protocol. The method 700 ends at step 720.

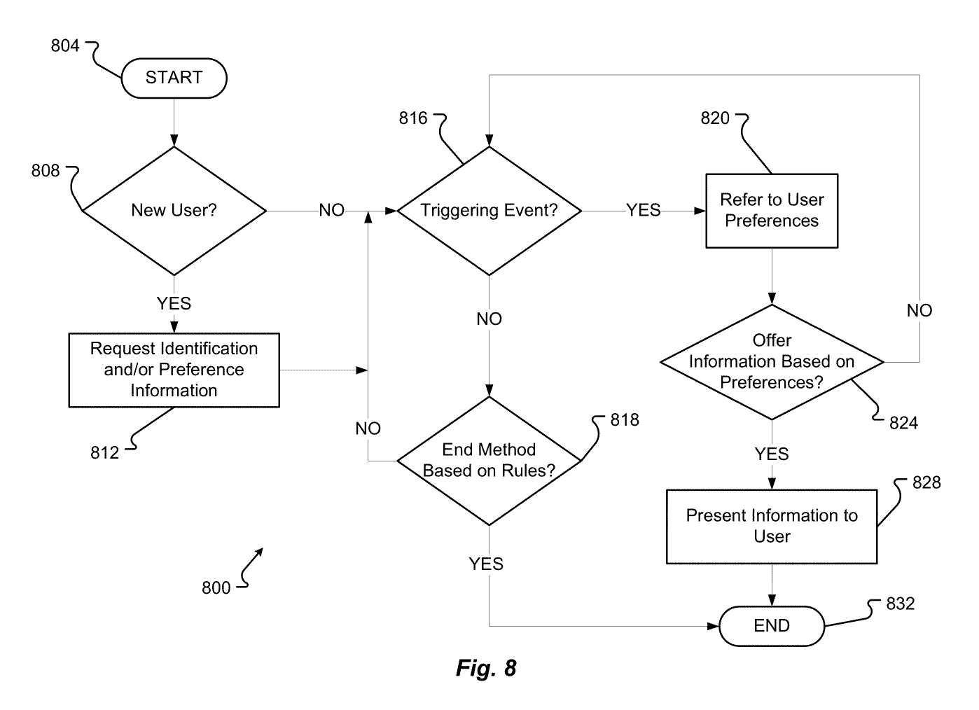

FIG. 8 is a flow diagram depicting a fourth method of a communication device application in accordance with embodiments of the present disclosure. In particular, the method 800 describes an ESID application, user 112 registration, and preferences in presenting information to a user 112. The method begins at step 804 and continues by determining whether the user 112 of the ESID application is a new or registered user (step 808). As can be appreciated, a registered user may have stored preferences and/or historical data that the ESID application may use in offering information to the registered user. These stored preferences and/or historical data may be associated with a username, or other identification, of the registered user 112. In accordance with embodiments of the present disclosure, the ESID application may automatically determine an existing user based at least partially on identifying the communication device 108 (e.g., using a Media Access Control (MAC) address associated with the device 108, or the like).

On the other hand, the user 112 may be determined to be a new user. In this case, the ESID may initially request identification and/or preference information from the new user (step 812). In some embodiments, the requested information may be stored in memory by the ESID application and/or management server 108 in a local and/or remote memory 120, 124. In an exemplary embodiment, a new user may register with the ESID application and/or management server 128 to identify as a registered user. Registering may include choosing a username or other identification and setting user preferences that can be associated with the registered user. Settings may be set automatically and/or in response to queries presented by the ESID application and/or management server 128.

In some embodiments, upon determining a user 112 identification, the method 800 continues by monitoring for a triggering event (step 816). If a triggering event does not occur, the method 800 may continue to monitor for triggering events or be directed to end based on rules (step 818). A triggering event may include receiving an encoded signal 212, an input to retrieve information, and other inputs received by a communication device 108.

The method 800 continues by referring to stored user preferences (step 820). The preferences may be stored locally and/or remotely. In some embodiments, user preferences may correlate to shopping data, historical analysis, preferred items, inquires, and other information associated with a user 112. Based on user preferences, the ESID application may determine to offer information to the user 112 (step 824). For example, a user 112 may have a pet cat and may want to receive information relating to cat food, litter, toys, and other cat-related offers. However, the user 112 may not want to receive information regarding all pet, or dog, deals. As such, the ESID application may refer to the user preferences to determine settings associated with the user 112. If an encoded signal 212 relates to a dog or other pet deal, the method 800 returns to monitoring for a triggering event (816). In an exemplary embodiment, the user 112 will not be notified, or alerted, of information available based on the preference information stored.

In some embodiments, the user may want to receive information regarding specific offers based on user preferences. In this case, the ESID application can present information to via the communication device 108. To continue with the previous example, a user 112 wanted to receive information related to cat toys and stored preferences related to that desire. A triggering event may be determined to contain information and/or offers relating to cat toys. In this instance, the user 112 will be presented information relating to the offer via the communication device 108. The information may include coupons, advertising details, product information and the like. In one embodiment, the user 112 may be presented with a website link and/or be directed to a manufacturer's website via the communication device 108. In some embodiments, the user 112 may be presented with a coupon code. The coupon code may be saved on the local memory 124 of the device 108. At checkout, the coupon code may be retrieved from the memory of the device 108. As can be appreciated, the coupon codes and/or other information can be stored locally and/or remotely. The coupon code and/or other information stored in memory may be programmed to expire after a given time period. Additionally or alternatively, the coupon code may expire depending on information received from a communication device 108. For instance, the communication device 108 may be offered a coupon code while the device 108 is located inside a store. However, when the device leaves the store, the coupon code could expire. This functionality may be achieved via location services such as GPS receivers, Wi-Fi access points, and/or cellular data. The method 800 ends at step 832.

FIG. 9 is a block diagram depicting a data structure 900 of a user profile in accordance with embodiments of the present disclosure. In particular, a communication device 108, management server 128, encoded signal source 104, and/or other components may use the data structure 900 or multiple similar data structures to facilitate the ESID application methods described herein. In some embodiments, a single data structure 900 may comprise the data necessary for the ESID application to deliver information based on encoded signals received. Alternatively, the communication device 108 and/or the management server 128, may employ the use of different data structures that may be similar but do not necessarily have to have the exact same data fields as shown in FIG. 9.

The example data structure 900 depicted comprises a plurality of data fields that contribute, at least in part, to the process of delivering information based on encoded signals received. Examples of such data fields include, without limitation, a user identification field 904, user location field 908, user preferences field 912, shopping cart field 916, wish list field 920, and other data field 924.

The user identification field 904 may comprise data which describes an identification of a user 112. In some embodiments, the user identification field 904 includes and identifier related to a particular communication device 108. Additionally or alternatively, the user identification field 904 may include a username, or code, to represent a user and other data.

The user location field 908, on the other hand, may comprise data relating to a physical location of the user 112 at a given point in time. It is anticipated that the user location field 908 may include historical data relating to locations of the user 112. This location information may be used by the ESID application to select offers for presentation to a user 112.

The user preferences field 912 may comprise data relating to communications preferences, alert settings, information types, state and/or behavior of the ESID application, and other information relating to a user 112. It is anticipated that a user may store information in the user preferences field 912 to customize the behavior of the ESID application. In some embodiments, the preferences stored in the user preferences field 912 may be pre-populated or preset by default and/or recommended values.

The shopping cart field 916 may comprise shopping data, coupons, advertisements, received information and other data relating to received encoded signals 212. In some embodiments, the shopping cart field 916 may include actual purchases made after receiving encoded signal 212 offers. This data may be stored to determine the effectiveness of coupons offered versus purchases made. The shopping cart field 916 may further comprise data relating to expired offers (e.g., via timers, geo-fencing, and the like).

The wish list field 920 may comprise data stored by a user 112 relating to items, products, and/or services that the user 112 may want to review at a later time. It is anticipated that a user 112 may be presented with multiple offers/information from encoded signal 212 deliveries. Therefore, the wish list field 920 may comprise a data location to store and/or log the offers that the user 112 may wish to review in the future. In some embodiments, the wish list field 920 may expire and renew after a given period of time. Additionally or alternatively, a user 112 may be reminded of data in the wish list field 920 from time to time.

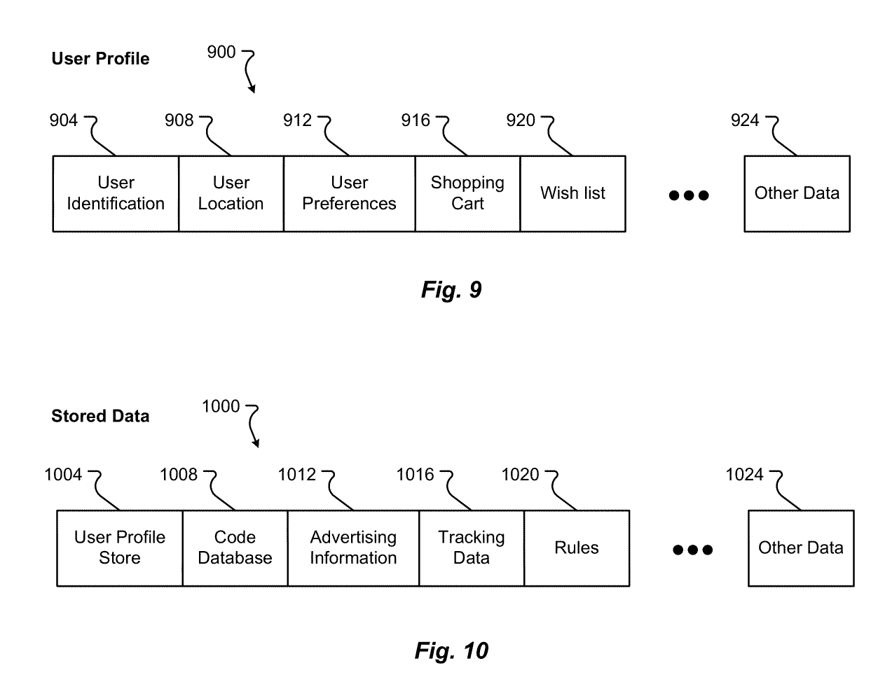

Referring to FIG. 10, a block diagram depicting a data structure 1000 of stored management data is shown in accordance with embodiments of the present disclosure. In particular, a communication device 108, management server 128, encoded signal source 104, and/or other components may use the data structure 1000 or multiple similar data structures to facilitate the ESID application methods described herein. In some embodiments, a single data structure 1000 may comprise the data necessary for the ESID application to deliver information based on encoded signals received. Alternatively, the communication device 108 and/or the management server 128, may employ the user of different data structures that may be similar but do not necessarily have to have the exact same data fields as shown in FIG. 10.

The example data structure 1000 depicted comprises a plurality of data fields that contribute, at least in part, to the process of delivering information based on encoded signals received. Examples of such data fields include, without limitation, a user profile store field 1004, code database field 1008, advertising information field 1012, tracking data field 1016, rules field 1020, and other data field 1024.

The user profile store field 1004 may comprise data relating to one or more registered users. This data may include user identifications, user devices, and more. In one embodiment, the data in the user profile store field 1004 may be contained in a database format. Upon determining a registered user the ESID application and/or management server 128 may refer to this database to determine preference and/or a user profile.

The code database field 1008 may comprise data relating to information associated with encoded signals 212. This information can be stored as codes. More specifically, these codes may include, but are not limited to, manufacturer details, advertisements, product information, news, interactive information, and/or other data associated with a registered code. For example a manufacturer may wish to use encoded signal 212 advertising and as such may register for a particular code associated with the intended advertising. The code may be correlated to a signal and the signal may be prepared for encoding in other signals as disclosed herein. The code database field 1008 may store these codes in memory to be referred to and/or reviewed. The code database field 1008 may reside locally and/or remotely. Furthermore, the code database may be managed by one or more organization. Benefits to organizational management include standard maintenance and accuracy of information.

The advertising information field 1012 may comprise data relating to advertising information used in the encoded signal 212 delivery methods. In some embodiments, the advertising information field 1012 may include one or more of website links, whitepapers, interactive advertisements, summaries, pictures, videos, sounds, and the like. It is anticipated that the information may be retrieved and correlated to one or more code stored in the code database field 1008.

The tracking data field 1016 may comprise data related to the habits and/or transactions of one or more users 112. This data may include one or more of database access attempts, user profile sizes, user preferences set, user locations, user stored information, and the like. In some embodiments, the tracking data field 1016 may be used to evaluate the efficiency and or rating of the encoded signal delivery system disclosed herein.

The rules field 1020 may comprise rules data relating to the ESID application. These rules may be used to determine application timeouts, states or modes, information retrieval, sending/transmission medium, display/presentation characteristics, and the termination and/or initiation of methods, to name a few. In some embodiments, the rules may be stored remotely in memory 120 and/or locally on a communication device 108 memory 124.

In an alternative embodiment, QR codes, barcodes, 2D codes, 3D codes, and other codes/symbols may be scanned and the information associated with the codes/symbols may be converted to inaudible tones. This process may be used to encode devices with information related to the codes/symbols. For example, the codes/symbols associated with various products, services, and/or information may be scanned and the scanned information can be encoded as inaudible tones. These inaudible tones may then be encoded onto devices such as portable tone emitters. Portable tone emitters may include any device configured to produce tones associated with an encoded symbol. It is an aspect of the present disclosure that one or more portable tone emitters may be used to clip onto shelves in a store, adhere to store windows, affix to real estate signs, merchandise, and the like. In some cases, the portable tone emitters may be located on or adjacent to some object for the purpose of providing information in the form of an encoded inaudible signal. Moreover, the portable tone emitters may be used and/or installed by manufacturers, retailers, service companies, individuals, and the like.

In some embodiments, the inaudible tones may be used to trigger secondary screens and/or devices for the presentation of information. In one embodiment, a device may interpret and/or receive an encoded signal (e.g., video, audio, and the like) and use the encoded signal to receive more information from additional sources/devices. For instance, a device may interpret and/or receive an encoded signal that causes the device to periodically, or continuously, emit inaudible tones to radio, video, and/or graphic billboard devices that are configured to respond to the emitted tones. These tones may be caused to emit based on the geographical location of the device, the presence of display/audio devices configured to respond to such tones, and/or the state of the device. In one example, a user may receive a first encoded signal via a first device from a first advertising point. Upon moving to a second advertising point, such as a graphic billboard or interactive kiosk, the first device may emit tones associated with the received encoded signal to initiate an interactive delivery of content. This content may include commercial information, advertisements, and/or other information related to advertising. In some embodiments, a device may be configured to emit tones on a timed basis (e.g., every five seconds for 20 minutes). Configuring a device to operate in this manner allows for dynamic advertising to follow a user based at least partially on user preferences and/or historical data.

The exemplary systems and methods of this disclosure have been described in relation to a communication device application and information delivery system. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments, and/or configurations illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices, such as a Personal Computer (PC), laptop, netbook, smartphone, Personal Digital Assistant (PDA), tablet, gaming device, scanner, etc., or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users' premises, or some combination thereof. Similarly, one or more functional portions of the system could be distributed between a telecommunications device(s) and an associated computing device

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In some embodiments, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method of providing information to a user, comprising:
receiving an identifier for a product or service, the identifier being provided in a first format;
converting the identifier for the product or service from the first format to a second format which includes one or more sound waves;
providing the identifier in the second format to a user device, wherein the identifier in the second format uniquely describes the product or service with altered properties of the one or more sound waves;
determining what product or service information is associated with the identifier; and
alerting the user that the product or service information is available.

2. The method of claim 1, wherein the second format comprises sound waves that are inaudible to the human ear.

3. The method of claim 1, wherein at least one of frequency, amplitude, and phase are altered in the one or more sound waves to uniquely identify the product or service.

4. The method of claim 1, further comprising, receiving the identifier in the second format at a user device; comparing the properties of the one or more sound waves to a database which maps properties of one or more sound waves to products and/or services; and identifying the product or service based on the comparing step.

5. The method of claim 1, wherein the first format comprises a bar code or QR code.

6. The method of claim 1, wherein the first format comprises an RF signal.

7. The method of claim 1, wherein the second format comprises sound waves that are audible to the human ear.

8. The method of claim 7, wherein the sound waves are configured to emulate ambient noise to the human ear.

9. The method of claim 7, wherein the sound waves are integrated into a melody.

10. A signal information delivery system comprising:
a receiver configured to receive product information from a first information source via a first format;
an encoding application configured to convert the product information from the first format into a second format; and
a transmitter configured to transmit the product information via a second signal in the second format.

11. The signal information delivery system of claim 10, wherein the second signal is one or more of radio waves and inaudible sound waves.

12. The signal information delivery system of claim 10, wherein the transmitter sends the second signal in response to an input received by the receiver.

13. The signal information delivery system of claim 10, wherein the transmitted tone is configured to automatically trigger a second display device to present the product information.

14. A communication device configured to receive encoded signals comprising:
a receiver adapted to receive the encoded signals;
a display configured to present information to at least one user; and
a non-transitory computer readable medium with instructions stored thereon that, when executed by a processor, performs the method comprising:
determining a state of the communication device, wherein the communication device state is one of Active mode, Monitor mode, and Off mode;
receive encoded signals at least partially based on rules associated with the state of the communication device; and
present information, via the display, to the at least one user based on the encoded signals.

15. The communication device of claim 14, wherein the Active mode enables the receiver to continuously seek the presence of the encoded signals while the display is in a fully powered state.

16. The communication device of claim 14, wherein the Monitor mode enables the receiver to periodically seek the presence of the encoded signals while the display is in a reduced power state.

17. The method of claim 16, wherein the communication device seeks the presence of the encoded signals for a predetermined period.

18. The method of claim 14, wherein the communication device seeks the presence of the encoded signals in response to receiving a query signal.

19. The method of claim 14, wherein prior to presenting the information, the method further comprises:
referring to stored preferences of a user associated with the communication device.

20. The method of claim 14, wherein the information is stored in memory.
